(19) United States
(12) Patent Application Publication
(10) Pub. No.: US 2019/0057139 A1
(43) Pub. Date: Feb. 21, 2019

(54) MASS DATA MOVEMENT MECHANISM

(71) Applicant: Facebook, Inc., Menlo Park, CA (US)

(72) Inventors: Peng Gao, San Jose, CA (US); Jian Li, Pleasanton, CA (US); Delia David, Mountain View, CA (US)

(21) Appl. No.: 15/681,280

(22) Filed: Aug. 18, 2017

(51) Int. Cl. G06F 17/30

(52) U.S. Cl. CPC G06F 17/30575; G06F 17/30589

(57) ABSTRACT

A computing system operates according to a method including: identifying a target set stored within a set of devices, wherein the target set includes data items that are designated to be copied to a different set of devices at a later time; determining a data preservation setting for each data item, wherein the data preservation setting represents a storage duration for the data; and generating a copy schedule based on the data preservation setting, wherein the copy schedule represents a timing for copying the each data item to the different set of devices.

### BACKGROUND

Computing systems are accessed by users to communicate with each other, share their interests, upload images and videos, create new relationships, etc. For example, social networking services and communication systems can execute on computing systems to enable users to communicate with each other through devices. The computing systems can operate in a distributed computing environment with data being distributed among and processed using multiple resources.

The resources can be located or grouped in hierarchical levels. For example, one datacenter can include multiple suites, where each suite includes numerous server racks that hold multiple servers. Based on the large number of servers within some groupings (e.g., datacenters or suites) and the increasing amounts of data stored and/or processed in each server, operations or movements performed at a group-level can involve massive amounts of data. As such, there is a need to improve efficiency in processing or moving the data to promote optimum use of the computing resources (e.g., computing capacity, storage capacity, or bandwidth).

### BRIEF DESCRIPTION OF THE DRAWINGS

FIG. 1 is block diagram illustrating an overview of a computing system in which some embodiments may operate.

FIG. 2 illustrates example input and output signals used to schedule the copy operation in accordance with various embodiments.

FIG. 3 illustrates further example input and output signals used to schedule the copy operation in accordance with various embodiments.

FIG. 4 is a flow chart illustrating a method of operating the computing system of FIG. 1, in accordance with various embodiments.

FIG. 5 is a functional block diagram of the computing system of FIG. 1, in accordance with various embodiments.

FIG. 6 is a block diagram of an example of a computing device, which may represent one or more computing devices or servers described herein, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

Various embodiments are directed to scheduling computing processes according to retention duration of the targeted data. For example, the various embodiments can be directed to saving network bandwidth used for copying data between datacenters based on scheduling the copy operation of the data according to a retention or purge schedule for the corresponding data.

In some embodiments, a computing system can store and/or process large amounts of data (e.g., multiple petabytes of data stored and/or processed daily), some of which can be processed according to physical sites or groupings of devices (e.g., such as copying data between datacenters). Due to the magnitude of the data, the processing between datacenters can take multiple days or weeks, or a month or more to complete. During the processing duration, some of the data targeted for the copy operation can expire (e.g., retention period for the data passes or a purge timing passes), which can lead to inefficiency and waste in processing resources (e.g., processing power, memory capacity, and bandwidth) from processing or copying the data that will be deleted thereafter without further use.

To reduce the inefficiency and waste, the computing system can check a target copy completion date as part of the copy process, and compare the target completion date to the retention information to schedule the copy operation. In some embodiments, for example, the computing system can schedule a data item to be copied after the expiry of the retention period when the end of the retention period for the data item expires before the target completion date. When the later date (e.g., a time after expiry) arrives, the computing system can copy the data that still exists (e.g., data that has not expired due to an update or change in the retention period) before copying the data, thereby avoiding copying of any data that will expire shortly after the process. If, however, the end of the retention period for the data item is after the target completion date or if the data is to be held indefinitely, the data item can be scheduled to be copied immediately.

In some embodiments, the computing system can schedule the data items based on sorting the data items according to the end of the retention period. For example, the computing system can schedule the data items to be copied in a reverse order according to the expiration date thereof (e.g., copying first the data items that are scheduled to be deleted last or held indefinitely, followed by the data items that are scheduled to be deleted sooner, and copying last the data items that are scheduled to be deleted first).

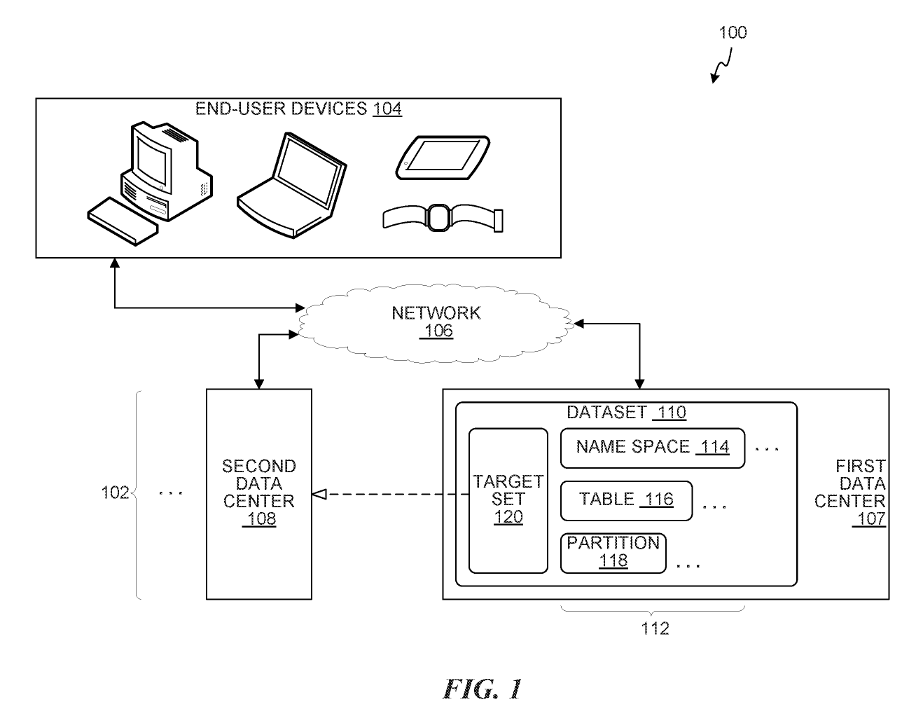

Referring now to the figures, FIG. 1 is block diagram illustrating an overview of a computing system 100 in which some embodiments may operate. The computing system 100 can include a social networking system or a communication system. The computing system 100 can include a service provider 102 (e.g., social networking service, internet service provider, or telecommunications or wireless communications service provider) connecting to and exchanging information with end-user devices 104 through an external network 106. The service provider 102 can use a circuit, a devices, a system, a function, or a combination thereof (e.g., servers, proxies, modems, switches, repeaters, or base stations) configured to manage communication or exchange of data between devices.

The end-user devices 104 can include one or more client computing devices (e.g., a wearable device, a mobile device, a desktop computer, a laptop, etc.,). The end-user devices 104 may operate in a networked environment using logical connections to one or more remote computers. The end-user devices 104 can connect to each other, the service provider 102, or a combination thereof. The end-user devices 104 can connect to other devices through the external network 106.

The external network 106 can include wired or wireless networks connecting various devices for communicating or exchanging data. For example, the external network 106 can include local area networks (LAN), wide area networks (WAN), wireless fidelity (WiFi) network, fiber optic networks, cellular network, the Internet, or a combination thereof.

The computing system 100 can include computing resources (e.g., units of circuitry, device, instructions, functions, or a combination thereof configured to automatically process information), such as servers of various types (e.g., database servers, file servers, web servers, game servers, or application servers) that provide functionalities to other programs or devices (e.g., the end-user devices 104 or other servers). The service provider 102 can have the servers organized or physically located in groups. For example, the servers can be grouped according to a rack, a suite, a datacenter, a region, etc. One or more datacenters (e.g., a first datacenter 107 and a second datacenter 108) can correspond to a geographic region, with each datacenter having one or more suites including multiple server racks. Each server rack can hold one or more servers.

The service provider 102 can process or store a set of data (e.g., a dataset 110 corresponding to a collection or a grouping of data items 112 stored or processed using a grouping of devices) using the grouped devices. For example, the service provider 102 can daily store and/or process multiple petabytes of data at each of the datacenters. The dataset 110 can represent the data items 112 that are stored or processed across the servers at one of the datacenter.

Each data item 112 can include a unit of information that corresponds to a logical or data structure. For example, the data item 112 can correspond to a name space 114 (e.g., a set of symbols or an indicator used to organize and/or name objects of various kinds), a table 116 (e.g., an organization or a grouping of the data items), a partition 118 (e.g., a logical subset or grouping of information), or a combination thereof. As a more specific example, the data item 112 can represent an activity log that corresponds to a particular instance of the name space 114, the table 116, the partition 118, or a combination thereof.

In addition to processing the data items 112 according to a need or a request (e.g., according to interactions with the end-user devices 104), the computing system 100 can internally process the data items 112 according to the device groupings (e.g., processing all or a set of data stored at a datacenter or a suite). For example, the computing system 100 can perform maintenance or housekeeping processes, including copying a target set 120 (i.e., a set of data items 112 corresponding to a particular grouping) from the first datacenter 107 to the second datacenter 108 to create redundancy or to geographically reallocate the items according to a geographical location of a user accessing or using the data.

In processing the data items 112 according to device groupings (e.g., for copying the data items 112 from the first datacenter 107 to the second datacenter 108), the computing system 100 (e.g., using one or more devices for the service provider 102) can schedule the copy operation according to retention or deletion information corresponding to the data items 112. For example, the computing system 100 can copy the data items 112 in a reverse order from the deletion schedule, thereby copying first the indefinitely stored items or last to be deleted items and copying last the items scheduled to be deleted first. Details for scheduling the copy operation are discussed below.

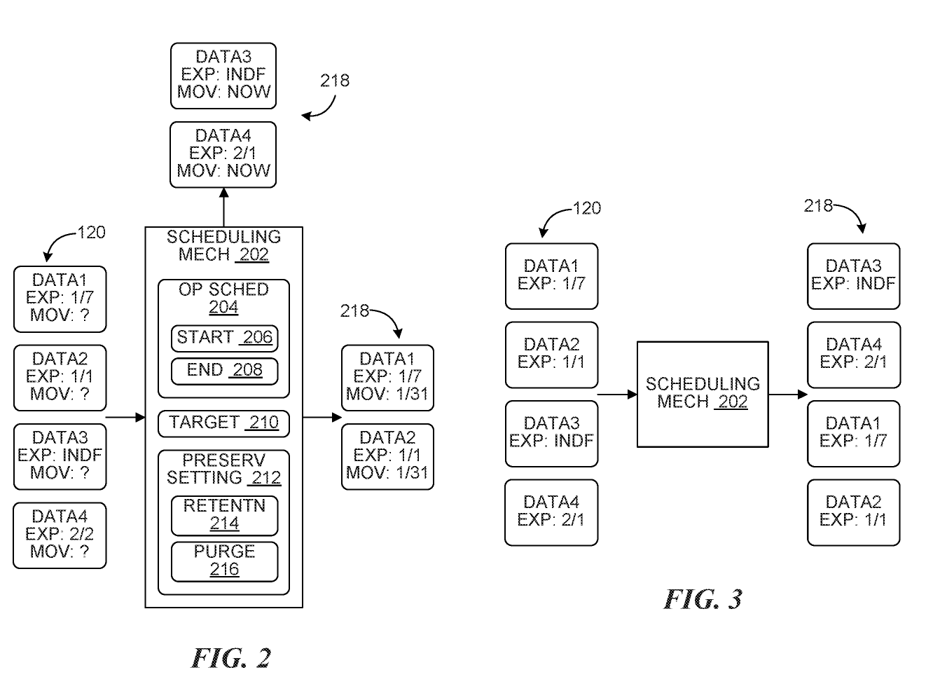

FIG. 2 illustrates example input and output signals used to schedule the copy operation in accordance with various embodiments. The computing system 100 of FIG. 1 can include a scheduling mechanism 202 (e.g., a method, a process, a device, a circuity, a software, a routine, or a combination thereof) configured to control a timing for processing the data items 112 of FIG. 1 across device groupings. For example, the scheduling mechanism 202 can determine when to copy the data items 112, which are in the target set 120 and stored at the first datacenter 107 of FIG. 1, to the second datacenter 108 of FIG. 1.

In some embodiments, the computing system 100 of FIG .1 can determine an operation schedule 204 for identifying a duration associated with group-level processing (e.g., copying) for the target set 120. The operation schedule 204 can include a start time 206 representing a time when the copy operation will begin, and an end time 208 representing a time when the copy operation will finish. The end time 208 can be a calculation or estimation result based on a size or a quantity of the target set 120 and available computing resources or rate (e.g., processing speed or bandwidth).

The computing system 100 can use the operation schedule 204 (e.g., the start time 206 and/or the end time 208) to determine a target time 210 (e.g., an arbitrary time determined by the computing system 100 and used to control the timing of the copy operations). For example, the computing system 100 can determine the target time 210 as the end time 208. Also for example, the computing system 100 can determine the target time 210 based on calculating a percentage of the duration between the start time 206 and the end time 208 or based on offsetting from the end time 208 by a predetermined duration.

In some embodiments, the computing system 100 can control the timing based on comparing the target time 210 with a data preservation setting 212 (e.g., information indicating a storage duration for the corresponding data item) of each data items 112. For example, the computing system 100 can use the target time 210 as a threshold and check if a retention schedule 214 (e.g., information representing how long the corresponding data item is to be held or stored) for a corresponding data table ends before or after the target time 210. Also for example, the computing system 100 can check if a purge timing 216 (e.g., information representing when the corresponding data item is scheduled to be deleted from the system) for a corresponding data partition occurs before or after the target time 210. When the expiry time is before the target time 210 or the retention period ends before the target time 210, the computing system 100 can schedule the corresponding data time to be copied at a time after the target date. When the expiry time is after the target time 210 or the retention period extends past the target time 210, the computing system 100 can schedule the corresponding data time to be copied immediately or before the target date.

For an example scenario illustrated in FIG. 2, the target set 120 can include the data items 112 labeled ‘DATA1,’ ‘DATA2,’ ‘DATA3,’ and ‘DATA4,’ and scheduled to be moved between January 1st and January 30th. The data items 112 can correspond to the preservation setting 212 of January 7th, January 1st, indefinite hold, and February 2nd, respectively. The preservation settings of the data items 112 in the target set 120 can be used as input signals in scheduling the copy of the data items 112.

For the example scenario, the computing system 100 can determine the target time 210 to be January 30th, same as the end time 208. The computing system 100 can use the scheduling mechanism 202 to sequentially (e.g., according to address or location within a table, shown in FIG. 2 as going from top to bottom) analyze each of the data items 112 in the target set 120 and compare the preservation setting 212 for each of the items with the target time 210. Since ‘DATA1’ and ‘DATA2’ have the expiry dates occurring before the target time 210, the computing system 100 can generate a copy schedule 218 (e.g., information specifying a timing for copying the corresponding data items) for scheduling ‘DATA1’ and ‘DATA2’ to be moved after the target time 210 (e.g., on January 31st or afterwards). Also, the computing system 100 can schedule ‘DATA3’ and ‘DATA4’ for immediately copying to the second datacenter 108 or for copying before the target time 210 since the expiry dates extend past the target time 210.

FIG. 3 illustrates further example input and output signals used to schedule the copy operation in accordance with various embodiments. In some embodiments, the computing system 100 of FIG. 1 can include the scheduling mechanism 202 configure to generate the copy schedule 218 by sorting the data items 112 of FIG. 1 according to the data preservation setting 212 of FIG. 2. For example, the computing system 100 can generate the copy schedule 218 for copying the data items 112 in a reverse order of the data preservation setting 212, thereby copying later the data item scheduled to expire or be deleted earlier and copying earlier the data items scheduled to expire later. The computing system 100 can generate the copy schedule 218 to copy first the data items 112 with indefinite storage indications for the data preservation setting 212, subsequently copy the latest or last expiring data item first, and finally copy the first or earliest expiring data item last.

For an example scenario illustrated in FIG. 3, the target set 120 can include the data items 112 labeled ‘DATA1,“DATA2,”DATA3,’ and ‘DATA4’ as discussed above in FIG. 2. The computing system 100 can use the scheduling mechanism 202 to generate the copy schedule 218 by sorting the data items 112 according to a reverse order (e.g., from latest to earliest) of the data preservation setting 212. The computing system 100 can generate the copy schedule 218 for copying first ‘DATA3’ with indefinite storage indication, followed by ‘DATA4’ with the latest date indicated by the data preservation setting 212 amongst the target set 120. The computing system 100 can likewise generate the copy schedule 218 to copy ‘DATA1’ after ‘DATA4,’ and ‘DATA2’ after ‘DATA1,’ according to the reverse order of the data preservation setting 212.

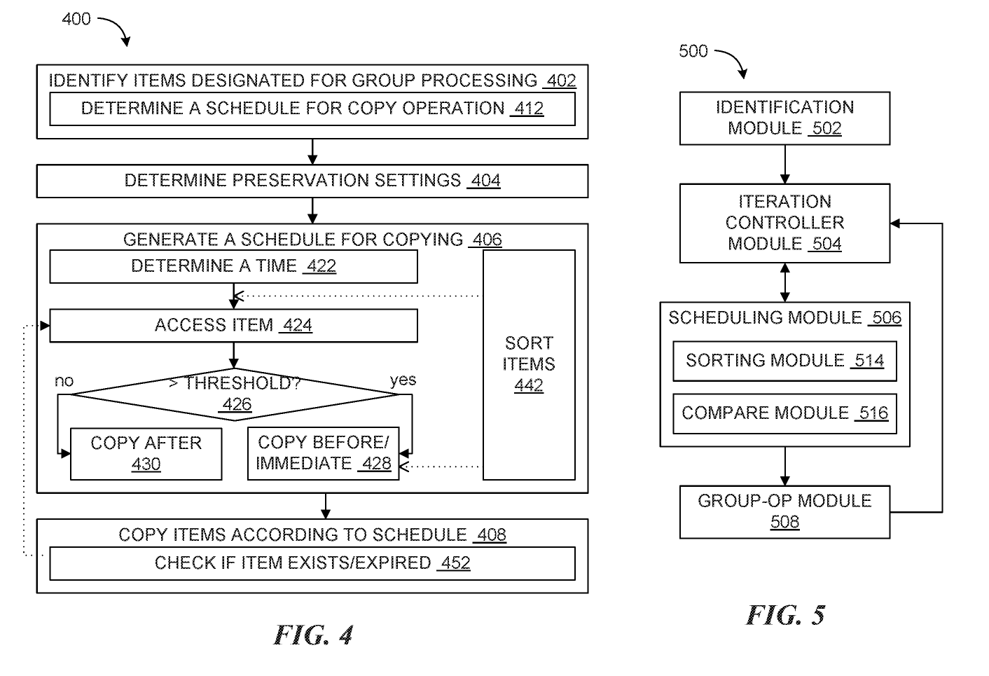

FIG. 4 is a flow chart illustrating a method 400 of operating the computing system 100 of FIG. 1, in accordance with various embodiments. The computing system 100 can schedule the data items 112 of FIG. 1 (e.g., data corresponding to the tables 116 of FIG. 1, the partitions 118 of FIG. 1, etc.) in the target set 120 for copying between device groupings (e.g., between servers grouped according to datacenters).

At a box 402, the computing system 100 (e.g., using one or more devices or processors at the service provider 102 of FIG. 1) can identify items designated for group processing (e.g., for processing according to device groupings). For example, the computing system 100 can use a device overseeing a set of datacenters, a controller managing devices within a data center, or a combination thereof to identify the target set 120 as the data items 112 (e.g., within a grouping of devices, such as the servers at the first datacenter 107 of FIG. 1)) that have been designated (e.g., by a separate device or process) to be copied to a different set of devices (e.g., the servers at the second datacenter 108 of FIG. 1) at a later time. The computing system 100 can identify by the target set 120 as all or a portion of the data items 112 stored in the corresponding device groupings.

The computing system 100 can identify the target set 120 designated according to user specification, an algorithm or a housekeeping process, etc. Such data items 112 can be identified based on their location or addresses within the sending set of devices, based on a flag or an indicator corresponding to the data items 112, based on a table listing an identifier or a storage location of the data items 112, based on receiving identifiers at the scheduling mechanism 202 from an identification mechanism, or a combination thereof.

Along with identifying the target set 120, the computing system 100 can determine a schedule for the overall copy operation at a box 412. The computing system 100 can determine the schedule by determining the operation schedule 204 of FIG. 2. The computing system 100 can determine the operation schedule 204 similarly as identifying the target set 120 (e.g., by accessing a specific location or by receiving the copy start time 206 of FIG. 2 and/or the copy end time 208 of FIG. 2 from a different mechanism). The computing system 100 can further determine the schedule by calculating the copy start time 206 and/or the copy end time 208 based on a size or amount of the target set 120. For example, the computing system 100 can calculate when the copying process can begin given the amount of data that needs to be copied and the projected loads or demands of the involved devices. Also for example, the computing system 100 can calculate when the process will end given a start time, the available resources (e.g., processing rate, bandwidth, etc.), and the size of the target set 120.

In some embodiments, the target set 120 can have a size in the order of petabytes (e.g., for data to be copied between datacenters). Due to the size of the data, copying the target set 120 can take multiple days, multiple weeks, one or more months, or a combination thereof. For example, a copy operation between datacenters can take 2-4 weeks or more. Accordingly, the computing system 100 can determine the operation schedule 204 corresponding to a duration lasting multiple days, multiple weeks, one or more months, or a combination thereof depending on the size of the target set 120, a size or a type of the device grouping, the available resources, or a combination thereof.

At a box 404, the computing system 100 can determine preservation settings for the designated data. The computing system 100 can determine (e.g., by accessing a table storing the expiry information and identities of the corresponding item, or by accessing within each item a location or a field that is designated to store the expiry information) the data preservation setting 212 of FIG. 2 of each data item in the target set 120. For example, the computing system 100 can determine the retention schedule 214 of FIG. 2 corresponding to each of the tables 116. Also for example, the computing system 100 can determine the purge timing 216 of FIG. 2 corresponding to each of the logical partitions 118.

At a box 406, the computing system 100 can generate a schedule for copying the designated data. The computing system 100 can generate the copy schedule 218 of FIG. 2 representing a timing for copying each of the data items 112 in the target set 120. The computing system 100 can generate the copy schedule 218 based on the data preservation setting 212, such as by scheduling based on comparing the data preservation setting 212 (e.g., the retention schedule, the purge timing, or both) to a threshold (e.g., the target time 210 of FIG. 2), by sorting the data items 112 according to their data preservation settings 212, or a combination thereof.

In some embodiments, the computing system 100 can schedule based on comparing the expiration of the data item to a threshold associated with the operation schedule 204. At a box 422, the computing system 100 can determine the threshold (e.g., the target time 210) used for evaluating the data preservation setting 212 of the data items 112.

The computing system 100 can determine the threshold based on the copy start time 206, the copy end time 208, or a combination thereof. For example, the computing system 100 can determine the target time 210 to be the same as the copy end time 208. Also for example, the computing system 100 can determine the target time 210 as a day or time preceding the copy end time 208 by a predetermined period. Also for example, the computing system 100 can determine the target time 210 based on a percentage or a fraction of the duration between the copy start time 206 and the copy end time 208. The computing system 100 can determine the target time 210 to be closer to the copy end time 208 than the copy start time 206. Also for example, the computing system 100 can determine the target time 210 based on a size of the target set 120, types of the data items 112, a categorization of the device grouping, or a combination thereof.

At a box 424, the computing system 100 can individually access the data items 112, such as according to an iterative process (e.g., for analyzing and scheduling the copy timing before the copy start time 206 or as part of the copying operation). The computing system 100 can access/process the data items 112 in the target set 120 according to an initial order or sequence in the target set 120. In some embodiments, the computing system 100 can determine the data preservation setting 212 of the accessed data item in addition to the operation illustrated in the box 404 or as an alternate configuration thereof.

At a box 426, the computing system 100 can compare the data preservation setting 212 of the corresponding item to the threshold. The computing system 100 can compare the data preservation setting 212 (e.g., the ending date or time of the retention schedule 214 or the purge timing 216) to the target time 210. In some embodiments, the computing system 100 can compare the data preservation setting 212 at or after the copy start time 206 as a check or a qualification that triggers or initiates copying of the accessed data item. In some embodiments, the computing system 100 can compare the data preservation setting 212 as part of a scheduling operation occurring before the copy start time 206.

At a box 428, the computing system 100 can generate the copy schedule 218 to copy the corresponding item before the copy end time 208 or the target time 210 when the corresponding item is determined to be expiring after the threshold. For example, the computing system 100 can signal (e.g., using a flag or an indication) to immediately initiate copying the accessed data item when the corresponding item expires after the target time 210. Also for example, the computing system 100 can keep the accessed data item in the target set 120, set the data item aside in a separate grouping for subsequent sorting operations, or a combination thereof when the corresponding item expires after the target time 210.

At a box 430, the computing system 100 can generate the copy schedule 218 to copy the corresponding item after the copy end time 208 or the target time 210 when the corresponding item is determined to be expiring before the threshold. For example, the computing system 100 can set the copy timing of the accessed data item to a designated date or period, such as the copy end time 208, the target time 210, or a time or a period occurring before or after the copy end time 208 or the target time 210. Also for example, the computing system 100 can set the data item aside in a further grouping of items designated to be copied after the copy end time 208 or the target time 210, or copied after copying all of the items that expire after the target time 210.

Scheduling the copy operation for the data items 112 in the target set 120 (e.g., by generating the copy schedule 218) based on the data preservation setting 212 improves efficiency of large-scale processes by removing unnecessary data items from being processed. For example, using the target time 210, the computing system 100 can identify the data items 112 that is set to expire before the copy operation is complete. The computing system 100 can copy other longer lasting data items first and schedule the identified items to be copied at a later time, thereby allowing the identified items to expire. If the data preservation setting 212 of the identified items are adjusted during the copying operation, extending the data preservation setting 212 past the copy end time 208 or the target time 210, the later scheduled time can allow for the corresponding items to be copied.

In some embodiments, the computing system 100 can schedule based on sorting the data items 112. At a box 442, the computing system 100 can generate the copy schedule 218, representing a sequence for copying the data items, based on sorting the data items 112 according to the data preservation setting 212. For example, the computing system 100 can use a sorting algorithm, such as simple sort, merge sort, heap sort, quick sort, bubble sort, shell sort, bucket sort, etc., to sort the data items 112 according to the data preservation setting 212.

The computing system 100 can generate the copy schedule 218 based on sorting the data items 112 in a reverse order (e.g., for copying later-erase data before earlier-erase data, where the later-erase data is designated to be deleted after the earlier-erase data). The computing system 100 can generate the copy schedule 218 to first copy data items corresponding to the data preservation setting 212 indicating permanent or unspecified storage duration before copying other data items corresponding to a specific and/or limited storage duration.

In some embodiments, the computing system 100 can use a combination of the iterative process and the sorting process discussed as examples above. For example, the computing system 100 can compare the data preservation setting 212 to the target time 210 while sorting, and determine the copy schedule 218 accordingly as discussed above. Also for example, the computing system 100 can sort the items before accessing the items (i.e., as represented by arrows with dotted lines located before the box 424 in FIG. 4). Also for example, the computing system 100 can sort the items identified to be deleted after the target time 210 (i.e., as represented by arrows with dotted lines located between the boxes 428 and 442 in FIG. 4).

At a box 408, the computing system 100 can copy the data according to the generated schedule. The computing system 100 can copy the data items 112 according to a corresponding timing specified by the copy schedule 218. In some embodiments, the computing system 100 can immediately copy the data items 112 that expire after the target time 210, such as part of the iterative process (i.e., as represented by a feedback look between boxes 408 and 424) that uses the comparison during the copy operation to trigger copying of each data item.

In some embodiments, the computing system 100 can copy the data items 112 starting at the copy start time 206 according to the copy schedule 218 generated before the copy start time 206. For example, the computing system 100 can copy the data items 112 identified for permanent or indefinite storage before other items with limited or specific storage duration. Also for example, the computing system 100 can copy the data items 112 according to a reverse order of the data preservation setting 212 (e.g., from the latest expiring to the earliest expiring).

Based on the scheduling, some data items can expire or be deleted during the overall copying operation (e.g., after the copy start time 206). As such, at a box 452, the computing system 100 can check if the data item originally scheduled for copy still exists or has expired before copying the data item. The computing system 100 can copy the data items 112 to the different set of devices (e.g., the servers at the second datacenter 108) when the data item 112 exists and has not been purged according to previously analyzed data preservation setting 212. Consequently, the computing system 100 can avoid copying any data items that would deleted during the overall copy operation, which provides increased efficiency in copying large amounts of data with various expirations.

While processes or boxes are presented in a given order, alternative embodiments may perform routines having steps, or employ systems having boxes, in a different order, and some processes or boxes may be deleted, moved, added, subdivided, combined, and/or modified to provide alternative or subcombinations. For example, the box 404 can be implemented as part of the box 424. Also for example, the computing system 100 can iteratively adjust the target time 210 as part of the sorting algorithm. The computing system 100 can start with the target time 210 set to the copy end time 208 and identify all items that expire after the target time 210. The computing system 100 can iteratively move the target time 210 closer to the copy start time 206 and schedule the corresponding items to be copied after the items identified in the previous iteration.

In addition, while processes or boxes are at times shown as being performed in series, these processes or boxes may instead be performed in parallel, or may be performed at different times. Each of these processes or boxes may be implemented in a variety of different ways. When a process or step is “based on” a value or a computation, the process or step should be interpreted as based at least on that value or that computation.

For illustrative purposes, the computing system 100 has been described above in the context of the social networking system or a communication system. However, it is understood that the computing system 100 can be applicable to different contexts, such as a network or a combination of devices or circuit components.

FIG. 5 is a functional block diagram of the computing system 100 of FIG. 1, in accordance with various embodiments. The computing system 100 can include an identification module 502, an iteration controller module 504, a scheduling module 506, a group-operation module 508, or a combination thereof. The identification module 502, the iteration controller module 504, the scheduling module 506, the group-operation module 508, or a combination thereof can be coupled to each other, such as using hardware connections (e.g., wires or wireless connections) or software connects (e.g., function calls, interrupts, input-output relationships, address or value settings, etc.).

The identification module 502 can be configured to identify the target set 120 of FIG. 1. The identification module 502 can be configured to implement the processes discussed above for the box 402 of FIG. 2. For example, the identification module 502 can identify the target set 120 and/or the data items 112 of FIG. 2 therein based on accessing a specific location or addresses corresponding to the target set 120, based on identifying a flag or an indicator corresponding to the data items 112, based on accessing a table listing an identifier or a storage location of the items belonging to the target set 120, based on receiving identifiers at the scheduling mechanism 202 of FIG. 2 from an identification mechanism, or a combination thereof. Also for example, the identification module 502 can implement the processes discussed above for the box 412 of FIG. 2 and determine an overall schedule for processing the target set 120 between device groupings (e.g., for copying the target set 120 in the first datacenter 107 to the second datacenter 108).

The iteration controller module 504 can be configured to control processing iterations (e.g., loops or recursions) associated with the overall group processing (e.g., the scheduling process, the copying process, or both). For example, the iteration controller module 504 can be configured to manage iterative evaluation or targeting of each data items 112 in the target set 120 for the scheduling process, for the overall process (e.g., copying the target set 120), or a combination thereof. The iteration controller module 504 can manage by incrementing any iteration counters, selecting the data item for each iteration, evaluating iteration conditions, or a combination thereof.

For each iteration, the iteration controller module 504 can access the data items 112 according to an initial order in the target set 120 for the scheduling process. For the overall process, the iteration controller module 504 can access the data items 112 according to the copy schedule 218 of FIG. 2.

The scheduling module 506 can be configured to schedule the data items 112 in the target set 120 for the overall group-operation process. The scheduling module 506 can be configured to implement the processes discussed above for the box 404 of FIG. 4, the box 406 of FIG. 4, or a combination thereof and generate the copy schedule 218. The scheduling module 506 can schedule the data items 112 based on sorting the data items 112 as discussed above for the box 442 of FIG. 4, based on comparing the data preservation settings 212 of FIG. 2 of the data items 112 to a threshold as discussed above for the boxes 422-430, or a combination thereof.

For example, the scheduling module 506 can include a sorting module 514 configure to sort the data items 112 according to the data preservation settings 212, such as in a reverse order as discussed above. Also for example, the scheduling module 506 can include a comparison module 516 configured to determine the threshold (e.g., the target time 210 of FIG. 2), compare the data preservation settings 212 to the threshold, and scheduling the copy operation for the analyzed data item according to the comparison as discussed above.

The group-operation module 508 can be configured to copy the target set 120 or one or more of the data items 112 therein. For example, the group-operation module 508 can copy the data items 112 located in the servers at the first datacenter 107 and duplicate them on the servers at the second datacenter 108.

The group-operation module 508 can implement the processes discussed above for the box 408 of FIG. 4 and the box 452 of FIG. 4, and copy the target set 120 according to the copy schedule 218. In some embodiments, the computing system 100 can implement the group-operation module 508 at the end of each iteration, such as for copying the evaluated data item based on a verification from the scheduling module 506 (e.g., that the evaluated item expires after the target time 210). In some embodiments, the computing system 100 can implement the group-operation module 508 as a set of iterations separate from the scheduling process. For example, the computing system 100 can use a first set of iterative processing to generate the copy schedule 218 before the copy start time 206. Starting at the copy start time 206, the computing system 100 can use a second set of iterative processing to copy the data items 112 according to the copy schedule 218.

One or more of the modules discussed above can be dedicated hardware circuitry or accelerator, a configuration of one or more processors, a configuration of data within memory, or a combination thereof. Also one or more of the modules discussed above, can software code or instructions that can be stored in memory, implemented using one or more processors, or a combination thereof. For example, each module can be a set of computer-executable instructions corresponding to a function or a routine. The computing system 100 (e.g., for one or more devices at the service provider 102 of FIG. 1) can include the one or more processors configured to implement (e.g., such as by loading or accessing) the instructions corresponding to the modules discussed above. The computing system 100 can use the one or more processors to implement the method 400 of FIG. 4 by implementing the instructions corresponding to the modules.

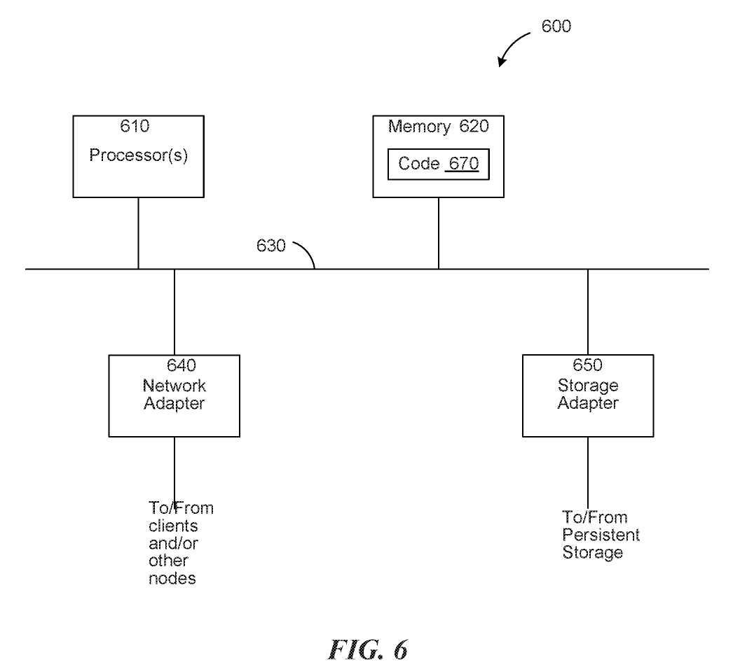

FIG. 6 is a block diagram of an example of a computing device 600, which may represent one or more communicating device or server described herein, in accordance with various embodiments. The computing device 600 can include one or more computing devices that implement the computing system 100 of FIG. 1. The computing device 600 can execute at least part of the method 400 of FIG. 4. The computing device 600 includes one or more processors 610 and memory 620 coupled to an interconnect 630. The interconnect 630 is an abstraction that represents any one or more separate physical buses, point-to-point connections, or both connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”. The interconnect 630 can also include wireless connection or communications between components.

The processor(s) 610 is/are the central processing unit (CPU) of the computing device 600 and thus controls the overall operation of the computing device 600. In certain embodiments, the processor(s) 610 accomplishes this by executing software or firmware stored in memory 620. The processor(s) 610 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 620 is or includes the main memory of the computing device 600. The memory 620 represents any form of random access memory (RAM), read-only memory (ROM), flash memory, or the like, or a combination of such devices. In use, the memory 620 may contain a code 670 containing instructions according to the operation of at least a portion of the computing system 100 or the method 300 disclosed herein.

Also connected to the processor(s) 610 through the interconnect 630 are a network adapter 640 and a storage adapter 650. The network adapter 640 provides the computing device 600 with the ability to communicate with remote devices, over a network and may be, for example, an Ethernet adapter, Fibre Channel adapter, or a wireless modem. The network adapter 640 may also provide the computing device 600 with the ability to communicate with other computers. The storage adapter 650 enables the computing device 600 to access a persistent storage, and may be, for example, a Fibre Channel adapter or SCSI adapter.

The code 670 stored in memory 620 may be implemented as software and/or firmware to program the processor(s) 610 to carry out actions described above. In certain embodiments, such software or firmware may be initially provided to the computing device 600 by downloading it from a remote system through the computing device 600 (e.g., via network adapter 640).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; and/or optical storage media; flash memory devices), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification. Reference in this specification to “various embodiments” or “some embodiments” means that a particular feature, structure, or characteristic described in connection with the embodiment is included in at least one embodiment of the disclosure. Alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments. Reference in this specification to where a result of an action is “based on” another element or feature means that the result produced by the action can change depending at least on the nature of the other element or feature.

What is claimed is:

1. A computer-implemented method, comprising:
identifying a target set stored within a set of devices, wherein the target set includes data items that are designated to be copied to a different set of devices at a later time;
determining a data preservation setting for each data item, wherein the data preservation setting represents a storage duration for the data; and
generating a copy schedule based on the data preservation setting, wherein the copy schedule represents a timing for copying the each data item to the different set of devices.

2. The computer-implemented method of claim 1, wherein generating the copy schedule includes:
determining a target time for representing a time associated with copying the target set; and
generating the copy schedule based on comparing the target time and the data preservation setting.

3. The computer-implemented method of claim 2, wherein generating the copy schedule includes generating the copy schedule to copy the data item after the data preservation setting expires when the data preservation setting expires before the target time.

4. The computer-implemented method of claim 3, further comprising:
checking for existence of the data item at a specific time according to the copy schedule, wherein the specific time is for initiating copying the data item, and
copying the data item to the different set of devices when the data item exists and has not been purged according to previously analyzed data preservation setting.

5. The computer-implemented method of claim 2, wherein generating the copy schedule includes generating the copy schedule to copy the data item before the target time when the data preservation setting of the data item expires after the target time.

6. The computer-implemented method of claim 5, wherein generating the designated includes generating the copy schedule to immediately initiate copying of the data item based on determining that the data preservation setting of the data item expires after the target time. The computer-implemented method of claim 2, wherein:
identifying the target set includes identifying the target set scheduled to be copied to the different set of devices between a copy start time and a copy end time; and
determining the target time includes determining the target time as the copy end time.

8. The computer-implemented method of claim 7, wherein identifying the target set includes identifying the data items stored at a datacenter and scheduled to be copied to a datacenter over a duration lasting multiple days, multiple weeks, one or more months, or a combination thereof.

9. The computer-implemented method of claim 2, wherein:
the data item includes tables;
the data preservation setting includes a retention schedule corresponding to each of the tables, wherein the retention schedule specifies how long the data for the corresponding table is to be stored; and
generating the copy schedule includes generating the copy schedule based on comparing the retention schedule to the target time.

10. The computer-implemented method of claim 2, wherein:
the data item includes logical partitions;
the data preservation setting includes a purge timing corresponding to each of the logical partitions, wherein the purge timing specifies when the data for the corresponding logical partition is to be deleted; and
generating the copy schedule includes generating the copy schedule based on comparing the purge timing to the target time.

11. The computer-implemented method of claim 1, wherein generating the copy schedule includes determining a sequence for copying the data items, wherein the sequence is determine based on sorting the data items according to the corresponding data preservation setting.

12. The computer-implemented method of claim 11, wherein generating the copy schedule includes sorting the data items in a reverse order for copying later-erase data before earlier-erase data, wherein the later-erase data is designated to be deleted after the earlier-erase data.

13. The computer-implemented method of claim 11, wherein generating the copy schedule includes scheduling to copy data items that correspond to the data preservation setting indicating permanent or unspecified storage duration before copying other data corresponding to storage for a limited duration.

14. The computer-implemented method of claim 1, wherein a size of the target set exceeds 1 petabyte.

15. A computer readable data storage memory storing computer-executable instructions that, when executed by a computing system, cause the computing system to perform a computer-implemented method, the instructions comprising:
instructions for identifying a target set stored within a set of devices and, wherein the target set includes data items that are designated to be copied to a different set of devices at a later time;
instructions determining a data preservation setting for each data item, wherein the data preservation setting represents a storage duration for the data; and
instructions for generating a copy schedule based on the data preservation setting, wherein the copy schedule represents a timing for copying the data item to the different set of devices.

16. The computer readable data storage memory of claim 15, wherein the instructions for generating the copy schedule includes:
instructions for determining a target time for representing a time associated with copying the target set; and
instructions for generating the copy schedule based on comparing the target time and the data preservation setting.

17. The computer readable data storage memory of claim 16, wherein the instructions for generating the copy schedule includes instructions for generating the copy schedule to copy the data item after the data preservation setting expires when the data preservation setting expires before the target time, and to copy the data item before the data preservation setting expires when the data preservation setting expires after the target time.

18. The computer readable data storage memory of claim 17, wherein the instructions for generating the copy schedule includes instructions for generating the copy schedule to immediately initiate copying of the data item based on determining that the data preservation setting expires after the target time.

19. The computer readable data storage memory of claim 18, wherein the instructions for generating the copy schedule includes instructions for determining a sequence for copying the data items, wherein the sequence is determine based on sorting the data items according to the corresponding data preservation setting.

20. The computer readable data storage memory of claim 19, wherein the instructions for generating the copy schedule includes instructions for sorting the data items in a reverse order for copying later-erase data before earlier-erase data, wherein the later-erase data is designated to be deleted after the earlier-erase data.
